(19) United States
(12) Patent Application Publication
(10) Pub. No.: US 2025/0329035 A1
(43) Pub. Date: Oct. 23, 2025

(54) METHOD AND SYSTEM FOR DETERMINING A CHARACTERISTIC DISTANCE OF AN OBJECT-OF-INTEREST

(71) Applicant: APPLICATIONS MOBILES OVERVIEW INC., Montreal (CA)

(72) Inventors: Laurent JUPPE, Montreal (CA); Sherif Esmat Omar ABUELWAFA, Montreal (CA); Bryan MARTIN, Montreal (CA); Hadrien ROTHEA, Montreal (CA); Antoine AUSSEDAT, Montreal (CA); Yann MAJEWSKI, Montreal (CA); Carla TOVAR, Montreal (CA)

(21) Appl. No.: 19/098,391

(22) Filed: Apr. 2, 2025

(30) Foreign Application Priority Data
Apr. 3, 2024 (EP) 24168343.2

(51) Int. Cl. G06T 7/564; G06T 7/12; G06T 7/60; G06T 7/73

(52) U.S. Cl. CPC G06T 7/564; G06T 7/12; G06T 7/60; G06T 7/74; G06T 2207/20076; G06T 2207/20081; G06T 2207/30196

(57) ABSTRACT

Methods of and systems for determining a characteristic distance of an object-of-interest. The method includes accessing a two-dimensional (2D) image of the object-of-interest, the 2D image comprising a plurality of pixels, each pixel being associated with a depth value indicative of a distance between an image sensing device that captured the 2D image and an entity present in the 2D image on the pixel, determining a contour of the object-of-interest on the 2D image, the contour defining an outline of the object-of-interest on the 2D image, determining an anchor pixel of the object-of-interest based on the contour thereof, determining a target segment on the 2D image and determining a length of the target segment based on a pixel length thereof and the depth value of a given pixel of the 2D image, the length of the target segment being the characteristic distance of the object-of-interest.

### FIELD

The present technology relates to systems and methods for characterization an object-of-interest. In particular, a system and methods for determining a characteristic distance of an object-of-interest are disclosed.

### BACKGROUND

Three-dimensional (3D) point clouds have broad applications in 3D modeling for characterisation of objects-of-interest. 3D point clouds are sets of data points, each data points being defined by a position (e.g. a set of cartesian coordinates) in a space such that the 3D point cloud represents a 3D shape of an object-of-interest. For example, 3D laser scanners such as long range laser scanners or short-range laser scanners may be used to generate those 3D point clouds.

However, performing geometrical measurements and characterization of an object-of-interest using a 3D point cloud may be a time-consuming process and may come with a relatively high computer complexity given the amount of data to be processed. Moreover, typical systems and method to capture 3D point cloud and then generate 3D representation of the object require specialized, inconvenient and costly hardware equipment. To this end, there is an interest in developing efficient and cost-effective systems and methods for determining characteristic distances of object-of-interest based on two-dimensional (2D) images thereof.

### SUMMARY

In a first broad aspect of the present technology, there is provided a computer-implemented method for determining a characteristic distance of an object-of-interest. The method includes accessing a two-dimensional (2D) image of the object-of-interest, the 2D image comprising a plurality of pixels, each pixel being associated with a depth value indicative of a distance between an image sensing device that captured the 2D image and an entity present in the 2D image on the pixel, determining a contour of the object-of-interest on the 2D image, the contour defining an outline of the object-of-interest on the 2D image, determining an anchor pixel of the object-of-interest based on the contour thereof, the anchor pixel being selected among the plurality of pixels of the 2D image within the contour of the object-of-interest, determining a target segment on the 2D image, the target segment containing the anchor pixel and crossing the contour in at least two pixels and determining a length of the target segment based on a pixel length thereof and the depth value of a given pixel of the 2D image, the length of the target segment being the characteristic distance of the object-of-interest.

In some non-limiting implementations, determining a contour of the object-of-interest includes determining the contour of the object-of-interest by, for each pixel of the 2D image, identifying the pixel as belonging to the object-of-interest in response to the corresponding depth value is below a distance threshold and discarding the pixel otherwise.

In some non-limiting implementations, determining an anchor pixel of the object-of-interest based on the contour thereof comprises employing a machine learning algorithm (MLA).

In some non-limiting implementations, determining an anchor pixel of the object-of-interest based on the contour thereof includes determining a hull of the contour of the object-of-interest on the 2D image, thereby determining a plurality of hull feature points, determining, based on relative distances between consecutive hull feature points, at least two points of interest along the contour and determining the anchor pixel based on the at least two points of interest.

In some non-limiting implementations, the hull is a convex hull, and determining at least two points of interest along the contour includes determining relative distances between consecutive convex hull feature points along the convex hull, identifying the two longest distances among the relative distances as two target hull segments and determining, for each of the target hull segments, a corresponding point of interest, the point of interest being the point of contour between the convex hull feature points of the target hull segment where an orthogonal distance to the target hull segment is maximized.

In some non-limiting implementations, the anchor pixel is equidistant to the two points of interest.

In some non-limiting implementations, the method further includes adjusting a position of the anchor pixel by determining a digital framework of the object-of-interest, the digital framework being a ramified 2D tree structure, the digital framework being representative of a base structure of the object-of-interest and determining an adjusted anchor pixel based on the anchor pixel and the digital framework.

In some non-limiting implementations, determining the adjusted anchor pixel includes determining an average line extending along the digital framework in a vicinity of the anchor pixel, the adjusted anchor pixel being a projection of the anchor pixel on the average line.

In some non-limiting implementations, determining a pixel length of the target segment includes defining a base segment extending orthogonally to the average line at the adjusted anchor pixel and defining a plurality of segments, each segment being angled at a pre-defined angle with respect to a consecutive segment of the plurality of segment.

In some non-limiting implementations, the given pixel is the adjusted anchor pixel.

In some non-limiting implementations, the given pixel is the anchor pixel.

In some non-limiting implementations, determining a target segment on the 2D image includes determining a pixel length of a plurality of segments, each segment containing the anchor pixel and crossing the contour in at least two corresponding pixels and selecting one of the segments as the target segment based on a pre-determined pixel-distance criteria.

In some non-limiting implementations, the pre-determined pixel-distance criteria is fulfilled when the segment is a shortest segment of the plurality of segments.

In some non-limiting implementations, determining a length of the target segment includes defining a neighborhood of pixels around the given pixel, determining pixel-scale value based on an average of ratios of a metric distance divided by a pixel distance between any two pixels of the neighborhood, the metric distance being determined based on the depth value associated with the corresponding pixels and intrinsic parameters of an imaging system that captured the 2D image, determining a number of pixels of the target segment and determining a length of the target segment based on the pixel-scale value and the number of pixels of the target segment.

In some non-limiting implementations, the metric distance is an Euclidian distance.

In some non-limiting implementations, the method further includes executing a smoothing operation on the contour prior to determining the anchor pixel.

In some non-limiting implementations, accessing a 2D image of the object-of-interest comprises accessing a plurality of 2D images of the object-of-interest, the plurality of 2D images representing a same portion of the object-of-interest, determining a contour of the object-of-interest on the 2D image comprises determining, for each 2D image of the plurality of 2D images, a contour defining an outline of the object-of-interest on the corresponding 2D image, determining an anchor pixel of the object-of-interest based on the contour comprises determining, for each 2D image of the plurality of 2D images, a respective anchor pixel based on the corresponding contour associated with the 2D image, determining a target segment on the 2D image comprises, determining, for each 2D image of the plurality of 2D images, a respective target segment containing the anchor pixel associated with the corresponding 2D image, the target segment crossing the contour associated with the corresponding 2D image in at least two pixels and determining a length of the second target segment comprises, determining, for each 2D image of the plurality of 2D images, a length of the corresponding target segment based on the pixel length thereof and the depth value of a given pixel of the corresponding 2D image, thereby providing a plurality of characteristic distance values for the object-of-interest.

In some non-limiting implementations, the method further includes determining a global characteristic distance of the object-of-interest by applying statistical operation to the plurality of characteristic distance values.

In some non-limiting implementations, the plurality of 2D images is a stream of ordered 2D images, the statistical operation being applied by ordering the plurality of characteristic distance values based on an order of their corresponding 2D image in the stream of images, determining local minimums or local maximums in the plurality of ordered characteristic distance values and determining the global characteristic distance based on the average of the local minimums or local maximums.

In some non-limiting implementations, the 2D image is a first 2D image and the characteristic distance is a first characteristic distance, the method further includes accessing a second 2D image of the object-of-interest, the first and second 2D image representing different portions of the object-of-interest, determining a second contour of the object-of-interest on the second 2D image, the second contour defining an outline of the object-of-interest on the second 2D image, determining a second anchor pixel of the object-of-interest based on the second contour, determining a second target segment on the 2D image, the target segment containing the second anchor pixel and crossing the contour in at least two pixels and determining a length of the second target segment based on the pixel length thereof and the depth value of a given pixel of the 2D image, the length of the target segment being the second characteristic distance of the object-of-interest.

In some non-limiting implementations, determining a second anchor pixel of the object-of-interest based on the second contour includes determining a second hull of the contour of the object-of-interest on the 2D image, thereby determining a plurality of second hull feature points, determining, based on relative distances between consecutive second hull feature points, at least two second points of interest along the second contour and determining the second anchor pixel based on the at least two second points of interest.

In some non-limiting implementations, the second hull is a convex hull, and determining at least two second points of interest along the second contour includes determining relative distances between consecutive second convex hull feature points along the second convex hull, identifying the two longest distances among the relative distances as two second target hull segments, determining, for each of the second target hull segments, a corresponding second point of interest, the second point of interest being the point of the second contour between the second convex hull feature points of the second target hull segment where an orthogonal distance to the second target hull segment is maximized.

In some non-limiting implementations, the second anchor pixel is equidistant to the two second points of interest.

In some non-limiting implementations, the method further includes adjusting a position of the second anchor pixel by determining a second digital framework of the object-of-interest, the second digital framework being a ramified 2D tree structure, the digital framework being representative of a second base structure of the object-of-interest and determining a second adjusted anchor pixel based on the second anchor pixel and the second digital framework.

In some non-limiting implementations, determining the second adjusted anchor pixel includes determining a second average line extending along the second digital framework in a vicinity of the second anchor pixel, the second adjusted anchor pixel being a projection of the second anchor pixel on the second average line.

In some non-limiting implementations, the object-of-interest is a human wrist, the first characteristic distance is a length of the human wrist, the second characteristic is a width of the human wrist. The method further includes determining a wrist circumference of the human wrist based on the length and the width of the human wrist.

In some non-limiting implementations, the method further includes determining a characteristic surface area and/or a characteristic volume of the object-of-interest based on the characteristic distance.

In a second broad aspect of the present technology, there is provided a system for determining a characteristic distance of an object-of-interest, the system comprising a controller and a memory storing a plurality of executable instructions which, when executed by the controller, cause the system to perform the method.

In a third broad aspect of the present technology, there is provided a non-transitory computer-readable medium comprising computer-readable instructions that, upon being executed by a system, cause the system to perform the method.

In the context of the present specification, unless expressly provided otherwise, a computer system may refer, but is not limited to, an “electronic device”, an “operation system”, a “system”, a “computer-based system”, a “controller unit”, a “monitoring device”, a “control device” and/or any combination thereof appropriate to the relevant task at hand.

In the context of the present specification, unless expressly provided otherwise, the expression “computer-readable medium” and “memory” are intended to include media of any nature and kind whatsoever, non-limiting examples of which include RAM, ROM, disks (CD-ROMs, DVDs, floppy disks, hard disk drives, etc.), USB keys, flash memory cards, solid state-drives, and tape drives. Still in the context of the present specification, “a” computer-readable medium and “the” computer-readable medium should not be construed as being the same computer-readable medium. To the contrary, and whenever appropriate, “a” computer-readable medium and “the” computer-readable medium may also be construed as a first computer-readable medium and a second computer-readable medium.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 illustrates a capture of two-dimensional (2D) images of an object-of-interest by an electronic device in accordance with some implementations of the present technology;

FIG. 2 depicts a representative computing environment of the electronic device of FIG. 1 for executing computer-implemented described in the present disclosure, in accordance with some implementations of the present technology;

FIG. 3 illustrates front and rear views of the electronic device of FIG. 1 in accordance with some implementations of the present technology;

FIG. 4 is a flow diagram of a pipeline for determining a characteristic distance of an object-of-interest in accordance with some implementations of the present technology;

FIG. 5 is a representation of a depth mask obtained from a two-dimensional (2D) image of the object-of-interest of FIG. 1 in accordance with some implementations of the present technology;

FIG. 6 illustrates a digital framework of the object-of-interest on the depth mask of FIG. 5;

FIG. 7 illustrates a convex hull of a contour of the object-of-interest in accordance with some implementations of the present technology;

FIG. 8 illustrates points of interest determined based on the convex hull of FIG. 7, and an anchor pixel in accordance with some implementations of the present technology;

FIG. 9 illustrates a portion of the digital framework in a vicinity of the anchor pixel for adjusting a position thereof in accordance with some implementations of the present technology;

FIG. 10 illustrates an average line determined based on the portion of the digital framework and a base segment for determining a characteristic distance of the object-of-interest of FIG. 1 in accordance with some implementations of the present technology;

FIG. 11 illustrates a plurality of segments used to identify a target segment for determining a characteristic distance of the object-of-interest of FIG. 1 in accordance with some implementations of the present technology;

FIG. 12 is a representation of pixels of the 2D image used to determine a pixel-scale value in accordance with some implementations of the present technology;

FIG. 13 is a chart of obtained measurements of a characteristic distance of the object-of-interest for a plurality of 2D images;

FIG. 14 illustrates a depth mask and a process for the identification of a target segment for determining a second characteristic distance of the object-of-interest of FIG. 1 based on another 2D image of the object-of-interest in accordance with some implementations of the present technology;

FIG. 15 is a chart of obtained measurements of the second characteristic distance of the object-of-interest for another plurality of 2D images;

FIG. 16 is a flow diagram of a pipeline for determining a circumference of the object-of-interest in implementations where the object-of-interest is a human wrist;

FIG. 17 illustrates a flow diagram showing operations of a method for determining a characteristic distance of an object-of-interest in accordance with some implementations of the present technology; and

FIG. 18 is a representation of a cluster of point of a contour of the object-of-interest at a high-curvature portion of the contour in accordance with some implementations of the present technology.

It should also be noted that, unless otherwise explicitly specified herein, the drawings are not to scale.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements that, although not explicitly described or shown herein, nonetheless embody the principles of the present technology.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes that may be substantially represented in non-transitory computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some implementations of the present technology, the processor may be a general-purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

In the context of the present disclosure, a digital framework of a 2D or 3D representation of an object is a ramified tree structure, the digital framework being representative of a base structure of the object. For example, the digital framework of a representation of an organic object may also be referred to as a “skeleton” of the object. In a plurality of aspects of the present technology, the framework of the object is determined under the form of a ramified tree structure. In the context of the present disclosure and to ease a reading thereof, a “framework” of an object representing a physical object is equivalent to a “digital framework” thereof and is a virtual representation of a framework of a physical object. As such, the ramified tree structure defines a base structure of the object. A ramified tree structure may or may not include ramifications.

With these fundamentals in place, we will now consider some non-limiting examples to illustrate various implementations of aspects of the present technology.

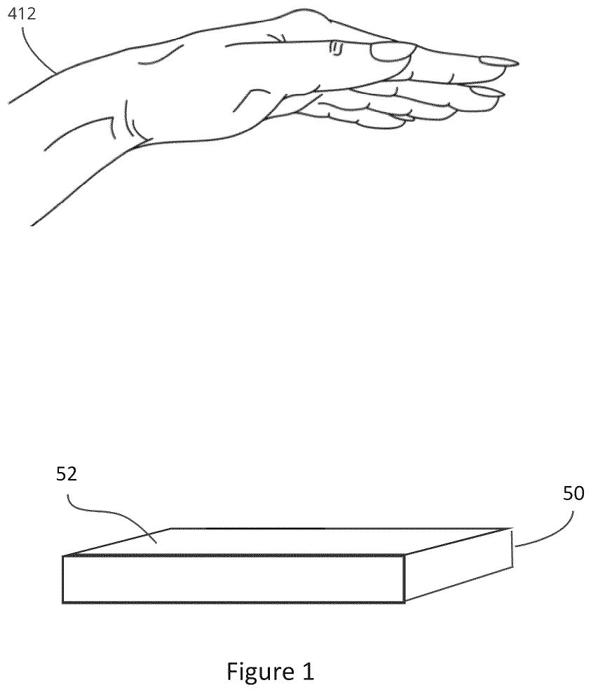

FIG. 1 illustrates a capture of two-dimensional (2D) images of an object-of-interest 412 by an electronic device 50 in accordance with some implementations of the present technology. In this illustrative example, the object-of-interest 412 is a human hand. As will be described in greater detail herein after, the electronic device 50 is configured to determining a characteristic distance of the object-of-interest 412. In the context of the present disclosure, a characteristic distance refers to a specific length or distance associated with the object-of-interest 412 that is used as a reference or measure for various purposes. The characteristic distance might represent the physical size or dimensions of the object-of-interest 412. A geometric definition of the characteristic distance may vary based on a type of the object-of-interest 412 and/or a current application for which the characteristic distance is determined.

In this implementation, a front side 52 of the electronic device 50 is oriented towards the object-of-interest 412. The front surface 116 may for example include sensors and imaging system to capture 2D images of the object-of-interest 412. As will be described in greater detail herein after, the 2D images include depth information of about the object of interest 412. For example a given 2D image may be a Red-Green-Blue-Depth (RGBD) image where each pixel of the 2D image is associated with color coordinates and a depth value indicative of a distance between an entity shown on said pixel and the imaging system that captured the 2D image.

The electronic device 50 may be associated with a user. As such, the electronic device 50 can sometimes be referred to as a “client device”, “user device” or “client electronic device”. It should be noted that the fact that the electronic device 50 is associated with a user does not need to suggest or imply any mode of operation—such as a need to log in, a need to be registered, or the like.

In one aspect, the present technology aims at determining a characteristic distance of the object-of-interest 412 based on 2D images thereof.

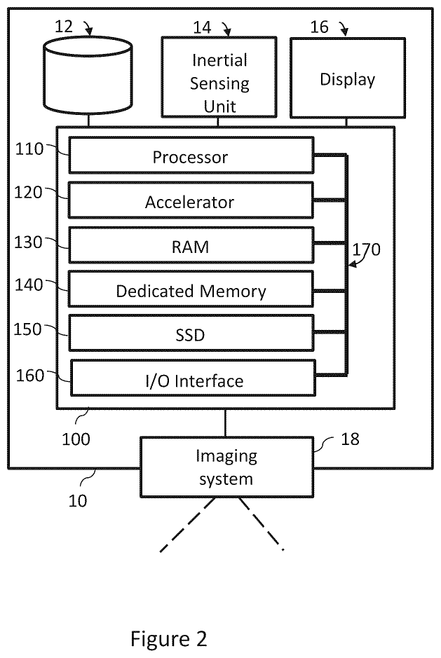

FIG. 2 is a schematic representation of an electronic device 10 in accordance with non-limiting implementations of the present technology. The electronic device 50 may be implemented as the electronic device 10. In some implementations, the device 10 includes a computing unit 100 configured to receive captured images or data related to an object-of-interest. The computing unit 100 is described in greater detail hereinbelow.

The device 10 includes an imaging system 18 that is configured to capture Red-Green-Blue (RGB) images and includes depth sensors to acquire RGB-Depth (RGBD) images. The imaging system 18 may include image sensors such as, but not limited to, Charge-Coupled Device (CCD) or Complementary Metal Oxide Semiconductor (CMOS) sensors and/or digital cameras. Broadly speaking, any device suitable for capturing RGBD images may be used as the imaging system 18 including but not limited to depth sensors. Imaging system 18 may convert an optical image into an electronic or digital image and may send captured images to the computing unit 100. The imaging system 18 may provide the device 10 with a continuous flux, or “stream”, of captured images. Thus, the captured images defined a continuous stream with a typical rate of 30 to 60 frames per second.

The device 10 may include an Inertial Sensing Unit (ISU) 14 configured to be used in part by the computing unit 100 to determine a pose of the imaging system 18 and/or the device 10. Therefore, the computing unit 100 may determine a set of coordinates describing the location of the imaging system 18, and thereby the location of the device 10, in a coordinate system based on the output of the ISU 14. Generation of the coordinate system is described hereinafter. The ISU 14 may include 3-axis accelerometer(s), 3-axis gyroscope(s), and/or magnetometer(s) and may provide velocity, orientation, and/or other position related information to the computing unit 100.

Further, the device 10 may include a screen or display 16 capable of rendering color images, including 3D images. In some implementations, the display 16 may be used to display live images captured by the imaging system 18, Augmented Reality (AR) images, Graphical User Interfaces (GUIs), program output, etc. In some implementations, display 16 may include and/or be housed with a touchscreen to permit users to input data via some combination of virtual keyboards, icons, menus, or other Graphical User Interfaces (GUIs). In some implementations, display 16 may be implemented using a Liquid Crystal Display (LCD) display or a Light Emitting Diode (LED) display, such as an Organic LED (OLED) display. In other implementations, display 16 may remotely communicably connected to the device 10 via a wired or a wireless connection (not shown), so that outputs of the computing unit 100 may be displayed at a location different from the location of the device 10. In this situation, the display 16 which may be operationally coupled to, but housed separately from, other functional units and systems in device 10. The device 10 may be, for example, an iPhone® from Apple or a Galaxy® from Samsung, or any other mobile device whose features are similar or equivalent to the aforementioned features. The device may be, for example and without being limitative, a handheld computer, a personal digital assistant, a cellular phone, a network device, a camera, a smart phone, an enhanced general packet radio service (EGPRS) mobile phone, a network base station, a media player, a navigation device, an e-mail device, a game console, or a combination of two or more of these data processing devices or other data processing devices.

The device 10 may include a memory 12 communicably connected to the computing unit 100 and configured to store data such as captured 2D images, depth values, sets of coordinates of the device 10, raw data provided by ISU 14 and/or the imaging system 18. The memory 12 may be embedded in the device 10 as in the illustrated implementation of FIG. 2 or located in an external physical location. The computing unit 100 may be configured to access a content of the memory 12 via a network (not shown) such as a Local Area Network (LAN) and/or a wireless connection such as a Wireless Local Area Network (WLAN).

The device 10 may also include a power system (not depicted) for powering the various components. The power system may include a power management system, one or more power sources (e.g., battery, alternating current (AC)), a recharging system, a power failure detection circuit, a power converter or inverter and any other components associated with the generation, management and distribution of power in mobile or non-mobile devices.

In some implementations, the computing unit 100 may be implemented by any of a conventional personal computer, a controller, and/or an electronic device (e.g., a server, a controller unit, a control device, a monitoring device etc.) and/or any combination thereof appropriate to the relevant task at hand. In some implementations, the computing unit 100 includes various hardware components. The computing unit 100 may be a computer specifically designed to operate a machine learning algorithm (MLA) and/or deep learning algorithms (DLA). The computing unit 100 may be a generic computer system.

In some other implementations, the computing unit 100 may be an “off the shelf” generic computer system. In some implementations, the computing unit 100 may also be distributed amongst multiple systems. The computing unit 100 may also be specifically dedicated to the implementation of the present technology. As a person in the art of the present technology may appreciate, multiple variations as to how the computing unit 100 is implemented may be envisioned without departing from the scope of the present technology.

Communication between the various components of the computing unit 100 may be enabled by one or more internal and/or external buses 170 (e.g. a PCI bus, universal serial bus, IEEE 1394 “Firewire” bus, SCSI bus, Serial-ATA bus, ARINC bus, etc.), to which the various hardware components are electronically coupled.

The input/output interface 160 may provide networking capabilities such as wired or wireless access. As an example, the input/output interface 160 may include a networking interface such as, but not limited to, one or more network ports, one or more network sockets, one or more network interface controllers and the like. Multiple examples of how the networking interface may be implemented will become apparent to the person skilled in the art of the present technology. For example, but without being limitative, the networking interface may implement specific physical layer and data link layer standard such as Ethernet, Fibre Channel, Wi-Fi or Token Ring. The specific physical layer and the data link layer may provide a base for a full network protocol stack, allowing communication among small groups of computers on the same local area network (LAN) and large-scale network communications through routable protocols, such as Internet Protocol (IP).

According to implementations of the present technology, the solid-state drive 120 stores program instructions suitable for being loaded into the RAM 130 and executed by the processor 110. Although illustrated as a solid-state drive 150, any type of memory may be used in place of the solid-state drive 150, such as a hard disk, optical disk, and/or removable storage media.

The processor 110 may be a general-purpose processor, such as a central processing unit (CPU) or a processor dedicated to a specific purpose, such as a digital signal processor (DSP). In some implementations, the processor 110 may also rely on an accelerator 120 dedicated to certain given tasks, such as executing the methods set forth in the paragraphs below. In some implementations, the processor 110 or the accelerator 120 may be implemented as one or more field programmable gate arrays (FPGAs). Moreover, explicit use of the term “processor”, should not be construed to refer exclusively to hardware capable of executing software, and may implicitly include, without limitation, application specific integrated circuit (ASIC), read-only memory (ROM) for storing software, RAM, and non-volatile storage. Other hardware, conventional and/or custom, may also be included.

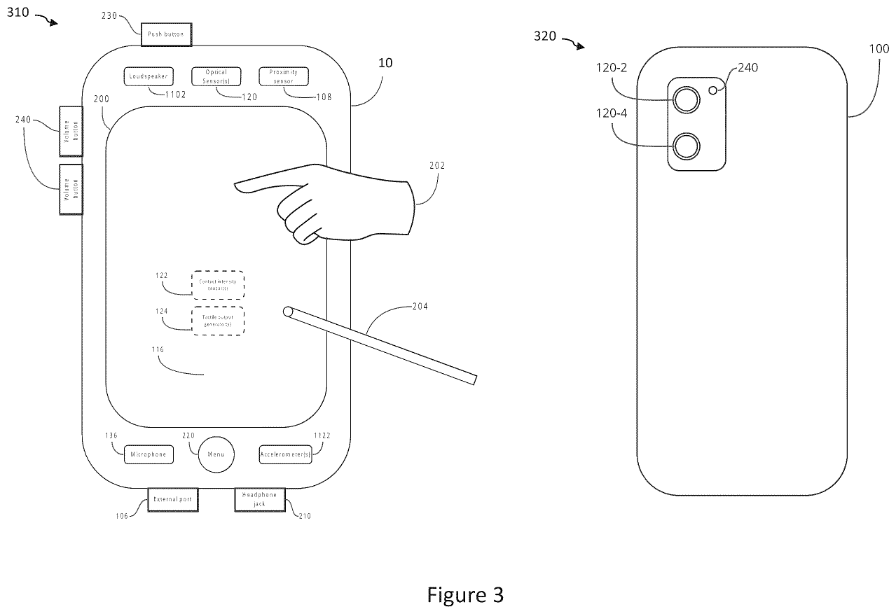

With respect to FIG. 3, representation 310 shows an illustrative and non-limiting example of a front side 312 of the electronic device 10. The front side 52 of the electronic device 50 may be implemented as the front side 312.

In some implementations, the electronic device 10 may include the touch-sensitive display 200, headphone jack 210, menu button 220, push button 230 for powering the device on/off and locking the electronic device 10, volume adjustment button(s) 240, and docking/charging external port 106. Push button 230 may also be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some implementations, the electronic device 10 may accept verbal input for activation or deactivation of some functions through microphone 136. The electronic device 10 may also include the at least one contact intensity sensor 122 for detecting intensities of contacts on touch-sensitive display system 116 and/or the at least one tactile output generator 124 for generating tactile outputs for a user of the electronic device 10.

The front side 312 of the electronic device 10 may also include a touch screen 116, that can be the display 16. The touch screen 116 may display the at least one graphic within user interface (UI) 200. In these implementations, a user may select the at least one graphic by making a gesture on the graphics, for example, with one or more fingers 202 (not drawn to scale in the figure) or one or more styli 204 (not drawn to scale in the figure). In some implementations, selection of one or more graphics occurs when the user breaks contact with the at least one graphic. In some implementations, the gesture may include the at least one tap, the at least one swipe (from left to right, right to left, upward and/or downward) and/or a rolling of a finger (from right to left, left to right, upward and/or downward) that has made contact with the electronic device 10.

In some implementations, the electronic device 10 may also include the at least one physical buttons, such as menu button 220. Menu button 220 may be used to navigate to any application 1060 in a set of applications that are, optionally executed on the electronic device 10. Alternatively, in some implementations, the menu button is implemented as a soft key in a GUI displayed on the touch-sensitive display 200.

Representation 320 of FIG. 3 depicts a back side 322 of the electronic device 10 in accordance with non-limiting implementations of the present technology. The back side 322 may include optical sensors 120-2 and 120-4, and at least one depth sensor 240 (such as a time-of-flight (“ToF”) sensor, a structured-light sensor or any other suitable sensor. The optical sensors 120, 120-2 and 120-4 are part of the imaging system 18 of the electronic device 10.

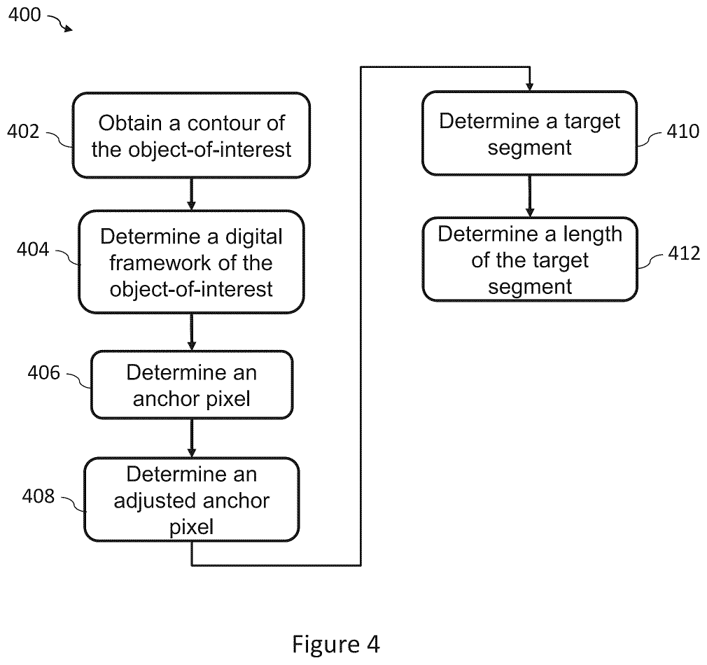

FIG. 4 depicts a high-level flow diagram of a pipeline 400 for determining a characteristic distance of the object-of-interest 412 in accordance with some implementations of the present technology. It is to be expressly understood that the pipeline 400 as depicted is merely an illustrative implementation of the present technology. In some cases, what are believed to be helpful examples of modifications to the pipeline 400 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case.

It will be understood that the pipeline 400 or the at least one steps thereof may be performed by a computer system, such the electronic device 10. The pipeline 400, or at least one step thereof, may be embodied in computer-executable instructions that are stored in a computer-readable medium, such as a non-transitory mass storage device, loaded into memory and executed by a CPU. Some steps or portions of steps in the flow diagram may be omitted or changed in order.

In use and as will be described in greater detail herein after, the computer unit 100 may access a 2D image of the object-of-interest 412 and obtain a contour of the object-of-interest on said 2D image at block 402. In some implementations, the computer unit 100 relies on the depth values of the pixels of the 2D image to determine the contour. More specifically, in this implementation, the computer unit 100 determines whether a given pixel belongs to the object-of-interest 412 by comparing the associated value with a distance threshold. For example, the given pixel may have an associated depth value of 0.3 m. The computer unit 100 compares the depth value with the distance threshold (e.g. 0.5 m). In this example, the pixel is identified as belonging to the object-of-interest 412 (i.e. representing a portion of the object-of-interest 412) in response to being below the distance threshold, and belonging to a background of the object-of-interest 412 otherwise. It can be said that the computer unit 100 determines a depth mask of the object-of-interest 412 on the 2D image.

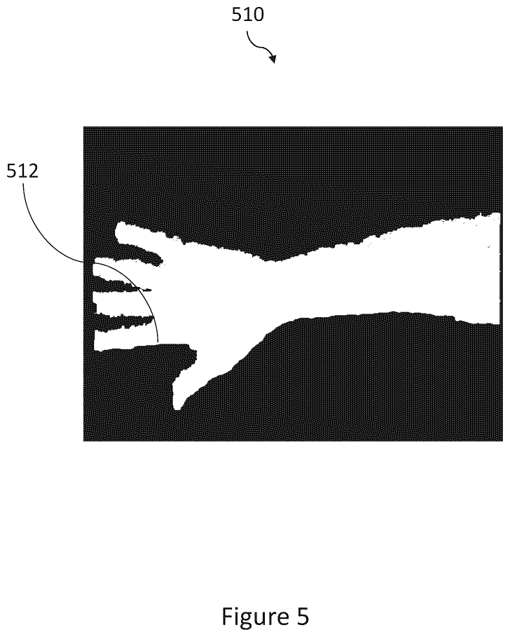

FIG. 5 illustrates a depth mask 510 of the object-of-interest where the pixels belonging to the object-of-interest 412 are depicted with a same color, and the pixels belonging to the background with another same color, thereby forming two sets of pixels. Therefore, a contour 512 may be determined as a limit or frontier between the two sets of pixels. The contour 512 may be further smoothed using known smoothing techniques.

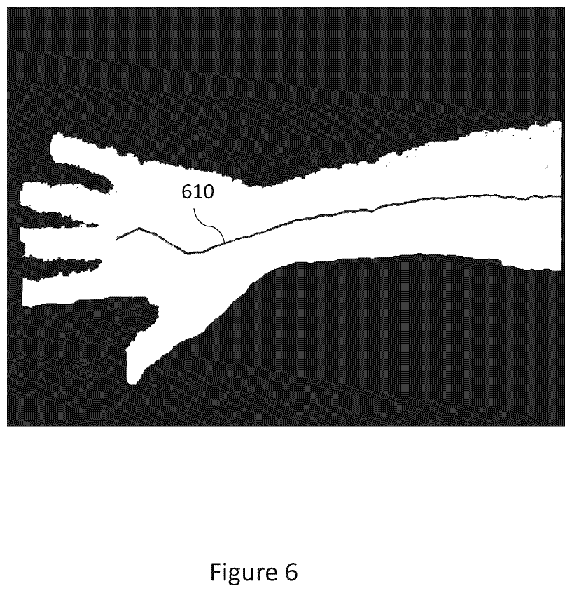

Referring back to FIG. 4, the computer unit 100 may further determine a digital framework of the object-of-interest 412 based on the contour 512 at block 404. An illustrative digital framework 610 is depicted on FIG. 6. Broadly speaking, the digital framework 610 may be an average line 610 generated based on iterations of contraction of the contour 512. Iteration may be performed until a single line is obtained, as the average line 610. More precisely, at each iteration, a contracted contour is generated based on a contraction of a contour generated at a prior iteration, starting from the contour 512. For example and without limitation, the contour may be iteratively smoothed and contracted into an approximate zero-surface degenerate line to generate the average line 610 that average the outer shape of the object. The average line 610 may be considered as a one dimensional (1D) structure.

The average line 610 may include one or more ramifications, a ramification being defined by a division of the average line 610 in a plurality of branches (i.e. a plurality of directions).

Once the average line 610 has been determined, the average line 610 may be interpolated and/or smoothed. This may be done to determine an estimation of a position of the skeleton within the contour 512 of the object-of-interest 412. Even though the present examples are oriented toward a human arm, the present technology may be used to characterize human body parts as well as other objects such as mechanical parts, tires, industrial parts and/or any other object.

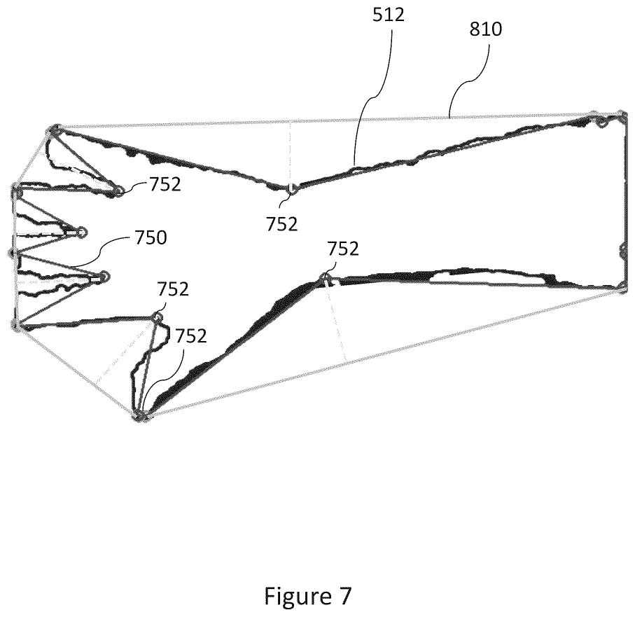

Referring back to FIG. 4, the computer unit 100 also determines an anchor pixel on the 2D image based on the contour 512 at block 406. It should be noted that operations of the blocks 404 and 406 may be executed in parallel or in series in any order. To do so, the computer unit 100 may determine a convex hull 810, as depicted on FIG. 7.

In some implementations, the computer unit 100 relies on the contour 512 (or a concave hull thereof) and the convex hull 810 to determines one or more points of interest that will be further used to determine the characteristic distance. In the illustrative example of FIG. 7, the convex hull 810 includes a plurality of feature points. For each pair of successive feature points along the convex hull 810 a maximal orthogonal distance is determined between the convex hull 810 and a portion of the contour 512 extending between said successive feature points. Convexity defect feature points 752 are identified on the contour 512 when the aforementioned distance is maximized, the convexity defect feature points 752 forming a convexity defect envelope 750 of the contour 512.

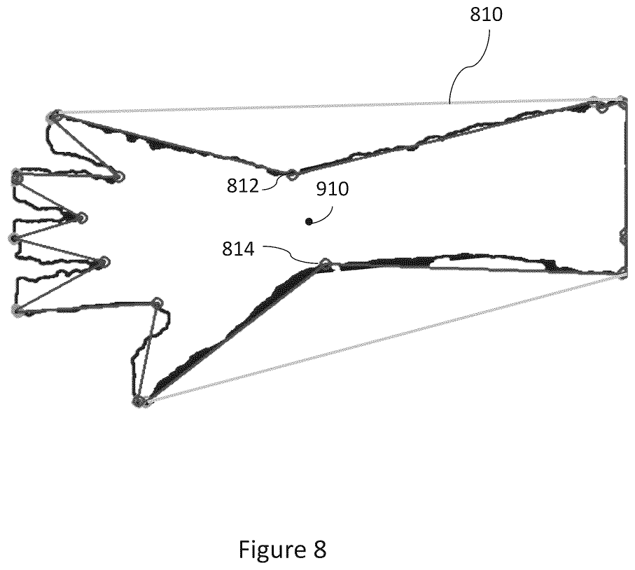

Referring now to FIG. 8, a first and a second convexity defect feature points 752 are identified as points of interest 812, 814. More specifically in this implementation, the computer unit 100 identifies the two longest segments of the convex hull 810, and the convexity defect feature points 812, 814 associated therewith.

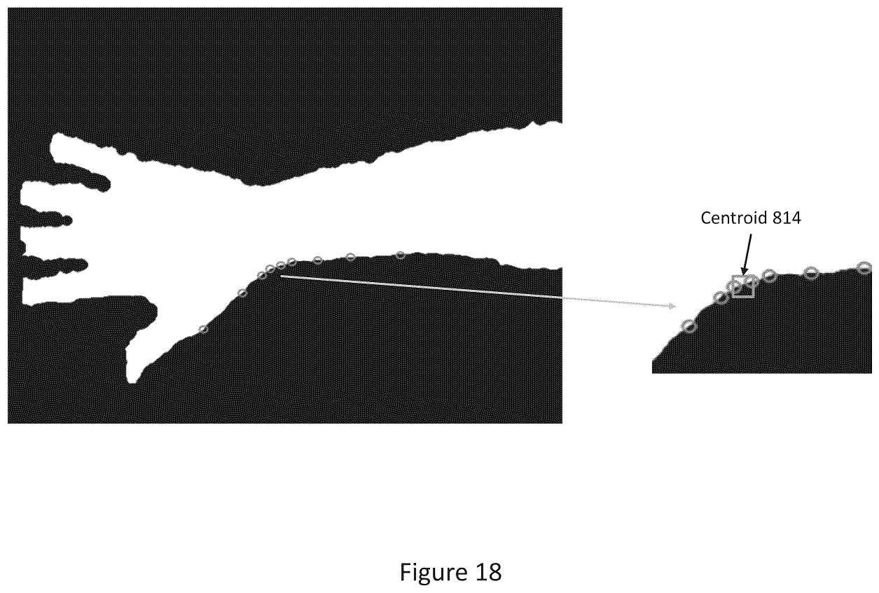

In some other implementations, a position of the points of interest 812, 814 is determined based on an alpha-shape of points of the depth mask 510. More specifically, in these implementations, the contour 512 is defined as an alpha-shape of the depth mask 510, thereby including a plurality of segments. Broadly speaking, portions of the alpha-shape with relatively high curvature include relatively more points than portions with relatively low curvature. Therefore, high-curvature portions correspond to shorter segments of the alpha-shape. In these implementations, a position of the points of interest 812, 814 may be adjusted to correspond to respective centroids of the two most dense clusters of points of the alpha-shape. In other words, among the plurality of linear simple curves of the alpha-shape, highest curvature portions of the contour 512 are defined by a higher number of segments and thus points at extremities of those segments, as represented on FIG. 18. The positions of the points of interest 812, 814 may then be obtained by being considered as the centroid of the densest clusters of points obtained by applying alpha-shape computation on the contour 512.

In some implementations, the alpha-shape methods described herein is applied to refine positions of the points of interest 812, 814 after applying the convexity defects calculation described above with respect to FIG. 7, the densest clusters points defining the most curved area of the alpha-shape being searched around the positions of the points of interest obtained by the convexity defects calculation.

An anchor pixel 910 may further be determined based on the points of interest 812, 814. For example, the anchor pixel may be the pixel of the 2D image that includes a middle point equidistant to the points of interest 812, 814.

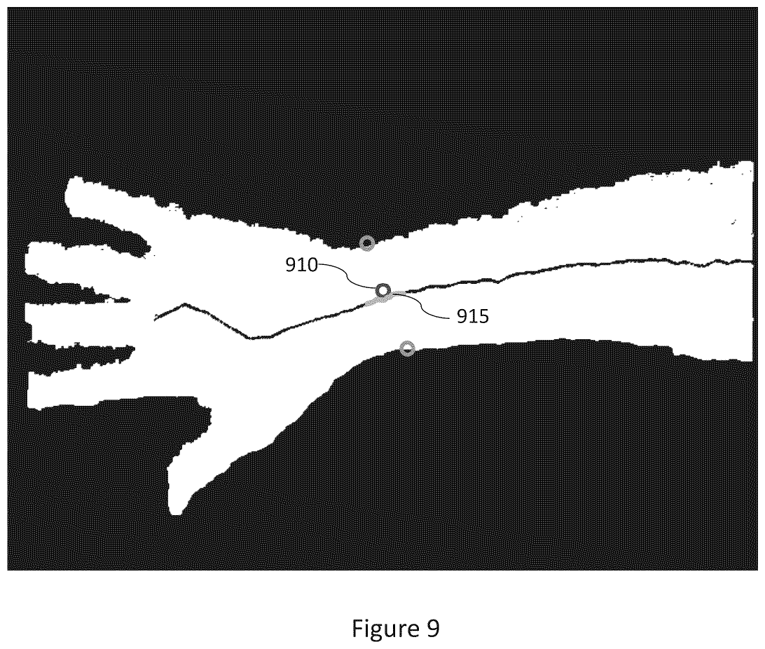

In some implementations, a position of the anchor pixel 910 is further adjusted based on the digital framework 610 of the object-of-interest 412. More specifically and with reference to FIG. 9, a neighborhood 915 of points is defined by pre-determined number of points of the digital framework 610 that are the closest to the anchor pixel 910. For example, fifty (50) points of digital framework 610 that are the closest to the anchor pixel 910 among the points of the digital framework 610 may define the neighborhood 915.

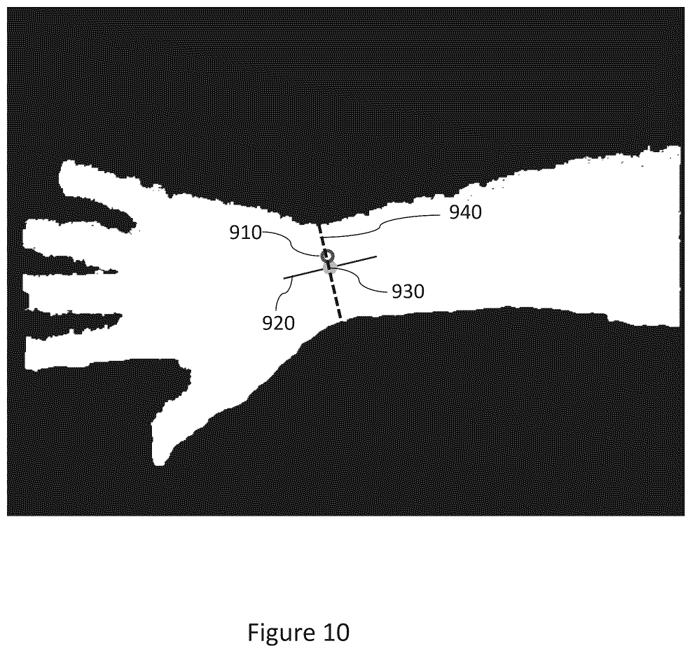

With reference to FIG. 10, the points of the neighborhood 915 are further averaged to define an average line 920 extending along the digital framework 610 in a vicinity of the anchor pixel 910. A position of the anchor pixel 910 is further orthogonally projected onto the average line 920, an adjusted anchor pixel 930 being the pixel of the 2D image that contains a projection of the orthogonal projection point on the average line 920.

In this implementation where the object-of-interest is a human wrist, a characteristic distance is defined as a length of the wrist. To measure said characteristic distance, a base segment 940 may be defined as extending orthogonally to the average line 920 at the adjusted anchor pixel 930, as shown on FIG. 10. The base segment 940 extends between two intersections with the contour 512. In some implementations, a target segment of the 2D image is the base segment 940 such that the characteristic distance is a length of the base segment 940.

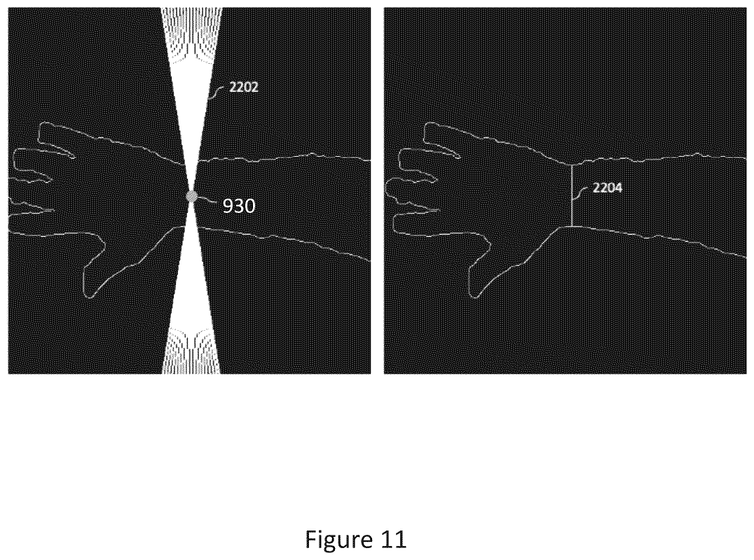

In some other implementations and with reference to FIG. 11, a plurality of segments 2202 are defined, each segment being angled at a pre-defined angle (e.g) 0.1° with respect to a consecutive segment of the plurality of segments, starting from the base segment 940. A maximal number of segments 2202 and/or a maximum angle with the base segment 940 may be pre-determined.

More specifically, a number of segments 2202 are iteratively defined along a clockwise rotation from the base segment 940, and a same number of segments 2202 are iteratively defined along a counter-clockwise rotation from the base segment 940. In these implementations, the target segment 2204 is the shortest segment among the segments 2202, as shown on FIG. 11. Broadly speaking, it can be said that the target segment is further selected based on a pre-determined pixel-distance criteria. In this example, the pre-determined pixel-distance criteria may be fulfilled when the segment is a shortest segment of the plurality of segments.

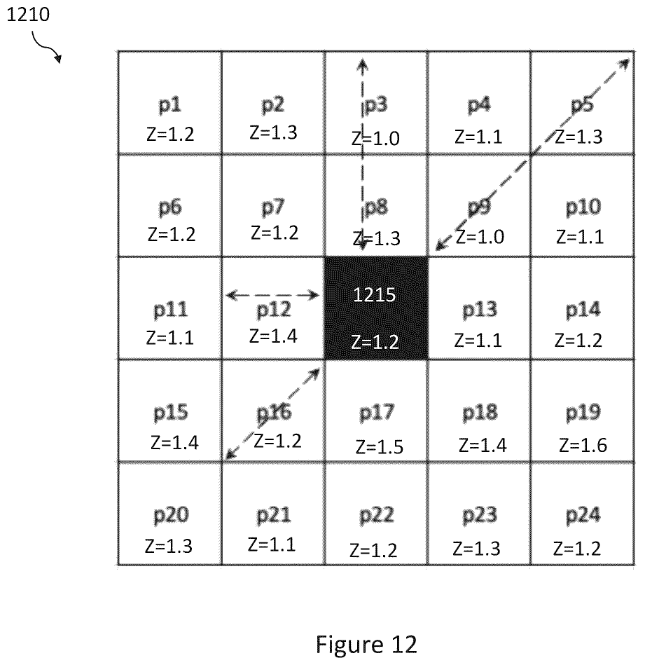

It should be noted that once the target segment 2204 has been identified, a measurable length thereof is a number of pixel. For example, the target segment 2204 may have a length of 23 pixels on the 2D image. FIG. 12 provides a process for determining a pixel-scale unit, which can be used to convert a pixel distance in a metric distance.

FIG. 12 is a representation of a neighborhood 1210 of pixels of the 2D image centered at a center pixel 1215. In some implementations, the center pixel 1215 is the anchor pixel 910 or the adjusted anchor pixel 930. As will be described in greater details herein after, the depth value associated with the pixels of the neighborhood 1210 of pixels may be used to determine a pixel-scale value in accordance with some implementations of the present technology. In the context of the present disclosure, the pixel-scale value is a ratio value indicative of a metric distance per pixel distance. More specifically, a unit of the pixel-scale value is millimeters per pixel and is used to convert distances in pixels to distances in metric units (e.g. Euclidian distance).

To do so, a size of the neighborhood 1210 in number of pixels between the center pixel 1215 and boundaries of the neighborhood 1210 is determined. The size may be predetermined in some implementations. In the example of FIG. 12, the size is n=2. Therefore, the neighborhood 1210 includes (2n+1)²−1=24 pixels in addition to the center pixel.

Each pixel i is further associated with a set of coordinates (X_{i,pixel}; Y_{i,pixel}; Z_{i,metric}), where X_{i,pixel} and Y_{i,pixel} are in pixels and Z_{i,metric} is the depth value associated with the pixel i. For example, for pixel i=1 (i.e. “p1” on FIG. 12), X_{1,pixel}=0, Y_{1,pixel}=0 and Z_{1,metric}=1.2 mm. As another example for pixel i=8 (i.e. “p8” on FIG. 12), X_{8,pixel}=2, Y_{8,pixel}=1 and Z_{8,metric}=1.3 mm.

It should be noted that Z_{i,metric} already has a value in the metric system. To obtain the values X_{i,metric} and Y_{i,metric} of X_{i,pixel} and Y_{i,pixel} in a metric system, the computer unit 100 may access intrinsic parameters of the imaging system 18 that captured the 2D image. More specifically, the metric values X_{i,metric} and Y_{i,metric} are obtained using the following equations:

$${X}_{i , metric} = ( ( {X}_{i , pixel} - {O}_{x} ) * {Z}_{i , metric} ) / {f}_{x} \\ {Y}_{i , metric} = ( ( {Y}_{i , pixel} - {O}_{y} ) * {Z}_{i , metric} ) / {f}_{y}$$

where Oₓ and O_{y} are the values in pixels of the offset of the principal point, from a top-left corner of the 2D image frame provided as intrinsic parameters of the imaging system 18, and fₓ and f_{y} are the values in pixels of the pixel focal length also provided as intrinsic parameters of the imaging system 18. It should be noted that the principal point refers to an intersection of the optical axis and the image plane of the imaging system 18. The image plane is a plane that is perpendicular to the optical axis at a distance from the optical center which is equal to the focal length of the imaging system 18.

Therefore, each pixel is associated with a set of pixel coordinates (X_{i,pixel}; Y_{i,pixel}; Z_{i,metric}) and a set of metric coordinates (X_{i,metric}; Y_{i,metric}; Z_{i,metric}). In some implementations, the computer unit 100 further determines a pixel distance (in pixels) based on the sets of pixel coordinates and a metric distance (in a metric system) based on the sets of metric coordinates between the center pixel 1215 and each point in the neighborhood 1210.

For example, a pixel distance between the center pixel 1215, or “CP”, and P3 is determined as: Dₚᵢₓₑₗ(CP;P3)=√((X_{CP,pixel}−X_{3,pixel})²+(Y_{CP,pixel}−Y_{3,pixel})²)=√((2−2)²+(2−0)²)=∇4=2 pixels.

As another example, a pixel distance between the center pixel 1215, or “CP”, and P5:

$${D}_{pixel} ( Anchor ; P 5 ) = √ ( {( {X}_{CP , pixel} - {X}_{5 , pixel} )}^{2} + {( {Y}_{CP , pixel} - {Y}_{5 , pixel} )}^{2} ) = √ ( {( 2 - 4 )}^{2} + {( 2 - 0 )}^{2} ) = √ 8 \approx 2 , 824 pixels .$$

For example, a metric distance between the center pixel 1215, or “CP”, and P3 is determined as: D_{metric}(CP;P3)=√(X_{CP,metric}−X_{3,metric})²+(Y_{CP,metric}−Y_{3,metric})²)=√(−0,8766877+0,730573)²+(−0,6546721+0,550147)²)=0,17965234 mm.

As another example, a metric distance between the center pixel 1215, or “CP”, and P5:

$${D}_{metric} ( C P ; P 5 ) = √ ( {( {X}_{CP , metric} - {X}_{5 , metric} )}^{2} + {( {Y}_{CP , metric} - {Y}_{5 , metric} )}^{2} ) = √ ( {( - 0 , 8766877 + \\ 0 , 9437819 )}^{2} + {( - 0 , 6546721 + 0 , 7151911 )}^{2} ) = 0 , 09035593 mm .$$

Optionally or alternatively, the computer unit 100 may convert the pixel coordinates (X_{i,pixel}; Y_{i,pixel}) into metric coordinates (X_{i,pixel}; Y_{i,pixel}) using the aforementioned formulas using intrinsic parameters, which are in this example fₓ=436.018, f_{y}=436.018, Oₓ=320.543 and O_{y}=239.874. In this implementation, metric coordinates of a given pixel such as P3 may further be determined by: X_{3,metric}=((X_{3,pixel}−Oₓ)*Z_{3,metric})/fₓ=−0,730573; Y_{3,metric}=((Y_{3,pixel}−Oy)*Z_{3,metric})/f_{y}=−0,550147.

The computer unit 100 further determines a relative distance between the center pixel 1215 and each pixel of the neighborhood 1210, the relative distance between two given pixels being a ratio between the metric distance between the given two pixels and the pixel distance between the given two pixels. For example, the relative distance between the center pixel 1215 and P3 and the relative distance between the center pixel 1215 and the pixel P5 may be expressed as:

$${D}_{relative} ( C P ; P 3 ) = {D}_{metric} ( C P ; P3 ) / {D}_{pixel} ( C P ; P 3 ) = 0 , 17965234 / 2 = 0 , 08982617 mm / pixel . \\ {D}_{relative} ( C P ; P 5 ) = {D}_{metric} ( C P ; P5 ) / {D}_{pixel} ( C P ; P 5 ) = 0 , 09035593 / 2 , 824 = 0 , 03199573 mm / pixel .$$

The computer unit 100 further determines an average of the relative distances (e.g. an median) between the center pixel 1215 and each pixel of the neighborhood 1210. Said average is a pixel scale value, denoted “PSV”, for the 2D image. It should be noted that the computer unit 100 may determine the PSV by averaging the relative distance between any two pixels of the neighborhood 1210 and not necessarily relative distances involving the center pixel 1215.

Therefore, the metric length of the target segment 2204 may be determined by measuring the pixel length thereof, directly measured on the 2D image, and multiple said pixel distance by the pixel scale value PSV. In the previous example, a metric length of the human wrist may thus be determined.

Once the metric length of the characteristic distance has been determined, a characteristic surface area and/or a characteristic volume of the object-of-interest 412 may be determined based on the characteristic distance.

In some implementations, a plurality of 2D images of a substantially same view of the object-of-interest 412 may be accessed by the computer unit 100. For example, a plurality of 2D images of the human wrist may be captured by the imaging system 18 while the human person maintains his wrist approximately in the same position in the field-of-view of the imaging system 18. Therefore, the computer unit 100 may determine a characteristic distance for each of the accessed 2D images by executing the pipeline 400 on each of the 2D images, thereby defining a plurality of characteristic distance values. For example, if forty (40) of 2D images of the substantially same view of the object-of-interest 412 are accessed by the computer unit 100, the computer unit 100 may determine forty characteristic distance values for the object-of-interest 412.

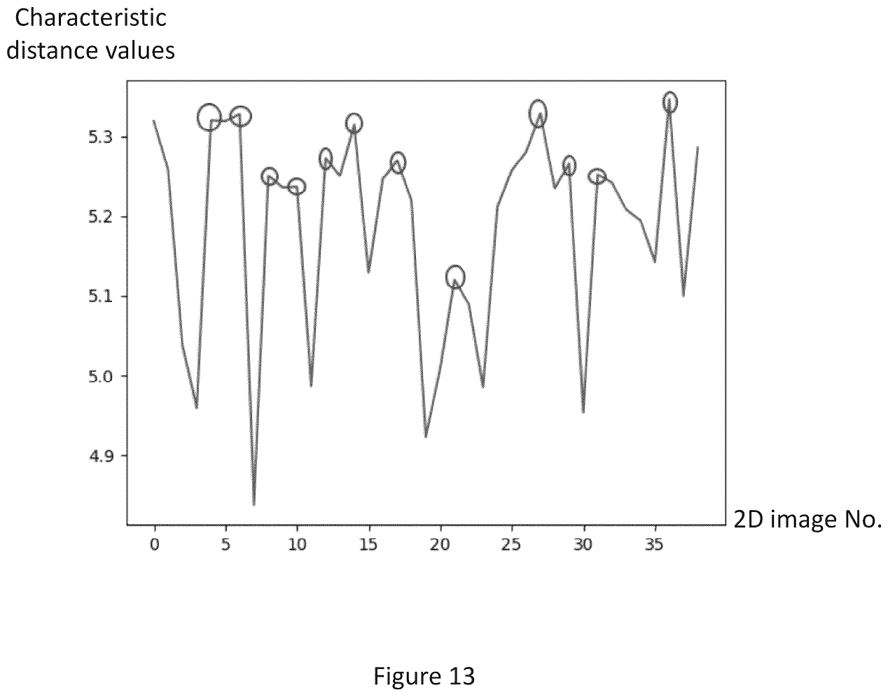

FIG. 13 illustrates the characteristic distance values determined for each captured 2D image. In this implementation, the plurality of 2D images have been captured as a stream of images, thereby defining an order (e.g. based on a chronological order of the captures) of the 2D images corresponding to the value on the horizontal axis on FIG. 13. A global characteristic distance of the object-of-interest 412 may be determined based on the plurality of by applying statistical operation to the plurality of characteristic distance values. In this example, the statistical operation includes identifying and averaging the local highs of the characteristic distance values (circled on FIG. 13) to define the global characteristic distance of the object-of-interest 412. Therefore, an accuracy of the measurement of the characteristic distance is increased. It should be noted that the characteristic distance values are metric values in FIG. 13, but the same calculations may be executed with pixel distances in alternative implementations.

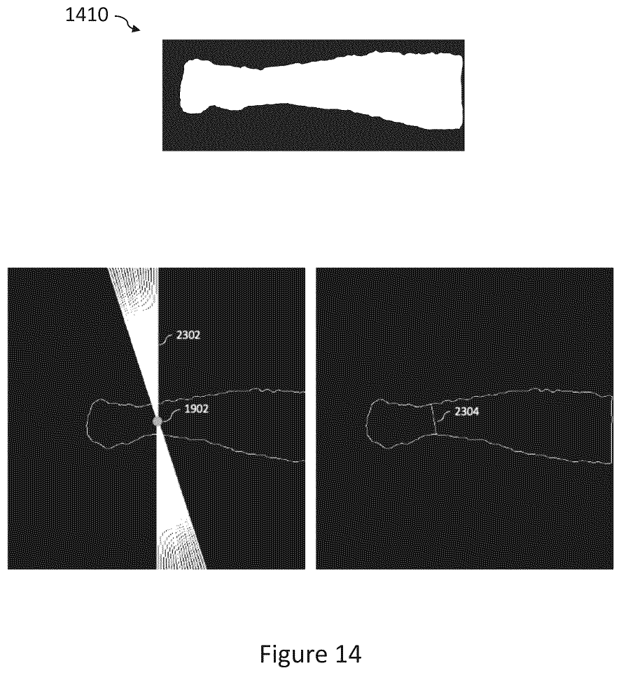

In some implementations, a second characteristic distance of the object-of-interest may be defined and determined by the computer unit 100. In these implementations, a second 2D image of a different view of the object-of-interest 412 is accessed by the computer unit 100 to execute the pipeline 400 thereon. In this example, the computing unit 100 determines a depth mask 1410 based on the second 2D image, as shown on FIG. 14. In this example, the second 2D image representative of a side of the human wrist that was captured on the first 2D image (see FIG. 5).

The computer unit 100 further executes the pipeline 400 on the second 2D image, thereby also defining an anchor pixel 1902, a plurality of segments 2302 defined in a same manner that the plurality of segments 2202 are defined, to obtain a second target segment 2204.

The length of the target segment 2204 thus corresponds to the second characteristic of the object-of-interest 412. In this example, the first characteristic distance related to the length of the target segment 940 is the length of the human wrist and the second characteristic distance related to the length of the target segment 2204 is the width of the human wrist.

In this implementation, a plurality of 2D images of the substantially same view of the object-of-interest 412 may be accessed by the computer unit 100 to determine a plurality of characteristic distance values for the second characteristic distance. For example, a plurality of 2D images of the human wrist may be captured by the imaging system 18 while the human person maintains his wrist approximately in the same position shown on FIG. 14. Therefore, the computer unit 100 may determine a characteristic distance for each of the accessed 2D images by executing the pipeline 400 on each of the 2D images, thereby defining a plurality of characteristic distance values.

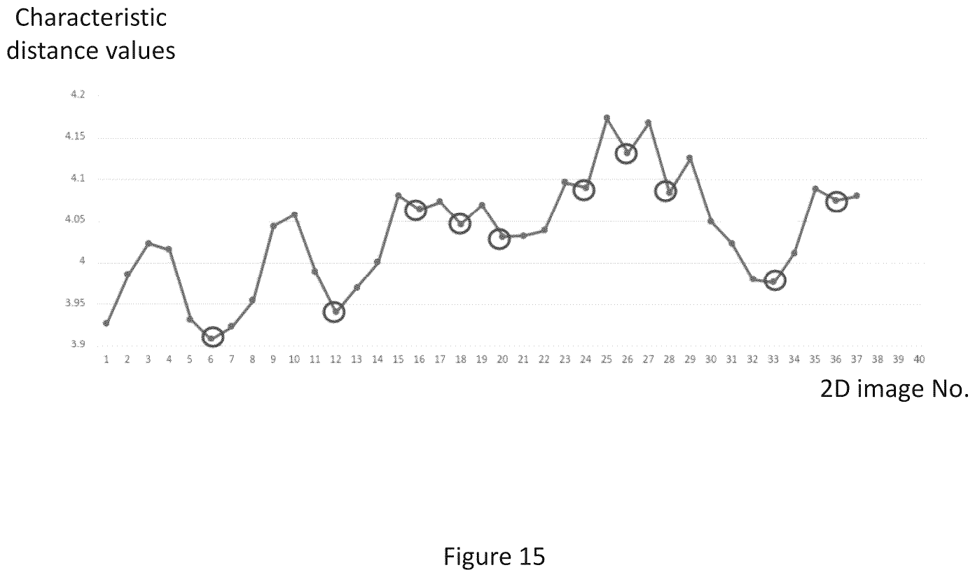

FIG. 15 illustrates the characteristic distance values determined for each captured 2D image. In this implementation, the plurality of 2D images have also been captured as a stream of images, thereby defining an order (e.g. based on a chronological order of the captures) of the 2D images corresponding to the value on the horizontal axis on FIG. 15. A second global characteristic distance of the object-of-interest 412 may be determined based on the plurality of by applying statistical operation to the plurality of characteristic distance values. In this example, the statistical operation includes identifying and averaging the local lows of the characteristic distance values (circled on FIG. 15) to define the second global characteristic distance of the object-of-interest 412. Therefore, an accuracy of the measurement of the second characteristic distance is increased. It should be noted that the characteristic distance values are metric values in FIG. 15, but the same calculations may be executed with pixel distances in alternative implementations.

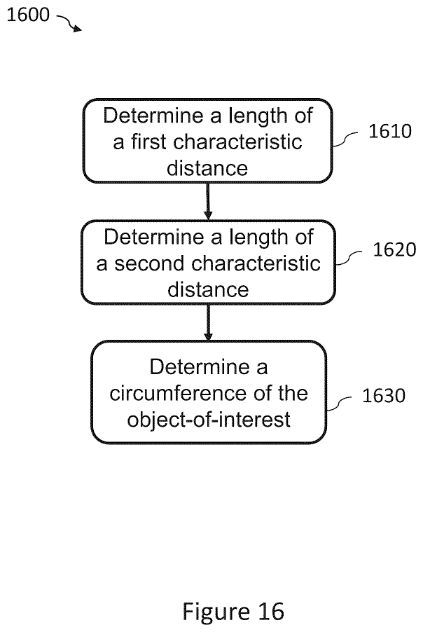

As shown on a pipeline 1600 on FIG. 16, the computer unit 100 may thus determine a length of a first characteristic distance of the object-of-interest 412 by executing the pipeline 400 on a first 2D image or on a first plurality of 2D images representative of a substantially same first view of the object-of-interest at block 1610. The computer unit 100 may further determine a length of a second characteristic distance of the object-of-interest 412 by executing the pipeline 400 on a second 2D image or on a second plurality of 2D images representative of a substantially same second view of the object-of-interest at block 1620 that is different from the first view. It should be noted that a plurality of characteristic distances of the object-of-interest 412 may be defined and further measured using 2D images of the object-of-interest 412 using methods described herein.

In this example, the first characteristic distance is a length a of the target segment 2204 (i.e. a length of the human wrist) and the second characteristic distance is a length b of the target segment 2304 (i.e. a width of the human wrist). The computing unit 100 may further determines a circumference c of the human wrist by:

$$c = 2 ( a - b ) + π \cdot b$$

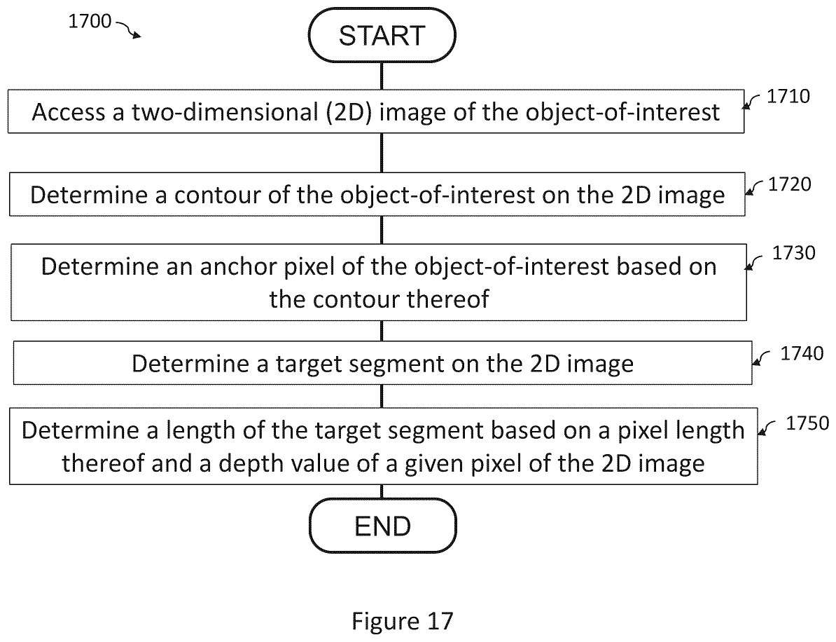

FIG. 17 is a flow diagram of a method 1700 for determining a characteristic distance of an object-of-interest, such as the object-of-interest 412, according to some implementations of the present technology. In one or more aspects, the method 1700 or one or more steps thereof may be performed by a processor or a computer system, such as the computer unit 100. The method 1700 or one or more steps thereof may be embodied in computer-executable instructions that are stored in a computer-readable medium, such as a non-transitory mass storage device, loaded into memory and executed by a CPU. Some steps or portions of steps in the flow diagram may be omitted or changed in order.

The method 1700 starts with accessing, at operation 1710, a two-dimensional (2D) image of the object-of-interest, the 2D image comprising a plurality of pixels, each pixel being associated with a depth value indicative of a distance between an image sensing device, such as the imaging system 18, that captured the 2D image and an entity present in the 2D image on the pixel.

The method 1700 continues with determining, at operation 1720, a contour of the object-of-interest on the 2D image, the contour defining an outline of the object-of-interest on the 2D image such as the contour 512. The contour may be defined by determining a depth mask of the object-of-interest on the 2D image. In some implementations, the contour is determined by identifying, for each pixel of the 2D image, the pixel as belonging to the object-of-interest in response to the corresponding depth value is below a distance threshold and discarding the pixel or identifying the pixel as belonging to the background of the object-of-interest otherwise.

The method 1700 continues with determining, at operation 1730, an anchor pixel of the object-of-interest based on the contour thereof, the anchor pixel being selected among the plurality of pixels of the 2D image within the contour of the object-of-interest. In some implementations, the anchor pixel is determined by determining a hull of the contour of the object-of-interest on the 2D image, such as the convex hull 810, thereby determining a plurality of hull feature points. The method 1700 further includes determining, based on relative distances between consecutive hull feature points, at least two points of interest along the contour such as the points of interest 812, 814. The anchor pixel may further be determined based on the at least two points of interest. For example, the hull may be a convex hull, such that relative distances between consecutive convex hull feature points along the convex hull may be determined to identify the two longest distances among the relative distances as two target hull segments. For each of the target hull segments, a corresponding point of interest is determined, the point of interest being the point of contour between the convex hull feature points of the target hull segment where an orthogonal distance to the target hull segment is maximized.

In some other implementations, the anchor pixel of the object-of-interest based on the contour thereof is determined by employing a machine learning algorithm (MLA).

In the same or other implementations, a position of the anchor pixel may be further adjusted. More specifically, the method 1700 may include determining a digital framework of the object-of-interest, the digital framework being a ramified 2D tree structure, the digital framework being representative of a base structure of the object-of-interest such as the digital framework 610. The method 1700 further includes determining an adjusted anchor pixel based on the anchor pixel and the digital framework. For example, an average line extending along the digital framework in a vicinity of the anchor pixel may be determined, such as the average line 920, the adjusted anchor pixel being a projection of the anchor pixel on the average line.

The method 1700 continues with determining, at operation 1740, a target segment on the 2D image, the target segment containing the anchor pixel and crossing the contour in at least two pixels.

In some implementations, the determination of the target segment on the 2D image includes determining a pixel length of a plurality of segments, each segment containing the adjusted anchor pixel and crossing the contour in at least two corresponding pixels. The target segment is further selected based on a pre-determined pixel-distance criteria. For example, the pre-determined pixel-distance criteria may be fulfilled when the segment is a shortest segment of the plurality of segments.

The method 1700 continues with determining, at operation 1750, a length of the target segment based on the pixel length thereof and the depth value of a given pixel of the 2D image, the length of the target segment being the characteristic distance of the object-of-interest. In some implementations, the method 1700 further includes determining a characteristic surface area and/or a characteristic volume of the object-of-interest based on the characteristic distance.

In some implementations, a determination of the pixel length of the target segment is made by defining a base segment extending orthogonally to the average line at the adjusted anchor pixel, such as the base segment 940 extending orthogonally to the average line 920. The method 1700 further includes defining a plurality of segments, each segment being angled at a pre-defined angle with respect to a consecutive segment of the plurality of segment, such as the plurality of segments 2202.

In some implementations, the method 1700 determines a length of the target segment by converting a pixel length of the target segment in a metric length. To do so, a neighborhood of pixels around a given pixel, such as the neighborhood 1210. The given pixel may be the adjusted anchor pixel or the anchor pixel.

The method 1700 further includes determining a pixel-scale value, or “PSV”, based on an average of ratios of a metric distance divided by a pixel distance between any two pixels of the neighborhood. In other words, the relative distances in mm/pixel between the pixels of the neighborhood may be averaged to determine the PSV. It should be noted that the metric distances are determined based on the depth value associated with the corresponding pixels and intrinsic parameters of the imaging system that captured the 2D image.

The method 1700 may further include determining a number of pixels of the target segment and determining a metric length (e.g. an Euclidian distance) of the target segment based on the PSV and the number of pixels of the target segment. The characteristic distance is the metric length of the target segment.

In some implementations, the method 1700 includes accessing a plurality of 2D images of the object-of-interest, the plurality of 2D images representing a same portion of the object-of-interest and executing the previous steps to each of the 2D images individually to determine a plurality of characteristic distance values for the characteristic distance. A statistical operation may further be applied to the plurality of characteristic distance values to determine a global characteristic distance. For example, the plurality of 2D images may a stream of ordered 2D images, the statistical operation being applied by determining local minimums or local maximums in the plurality of ordered characteristic distance values and determining the global characteristic distance based on the average of the local minimums or local maximums.

In the same or other implementations, the method 1700 may also includes accessing a second 2D image of the object-of-interest, representative of a different portion (i.e. a different view) of the object-of-interest. The previously described steps may be executed on the second 2D image to determine a second characteristic distance. For example, the object-of-interest may be a human wrist, the first characteristic distance being a length of the human wrist and the second characteristic distance being a width of the human wrist. In this example, the method 1700 may further include determining a wrist circumference of the human wrist based on the length and the width of the human wrist.

While the above-described implementations have been described and shown with reference to particular steps performed in a particular order, it will be understood that these steps may be combined, sub-divided, or re-ordered without departing from the teachings of the present technology. The steps may be executed in parallel or in series. Accordingly, the order and grouping of the steps is not a limitation of the present technology.

It will be appreciated that at least some of the operations of the method 1300 may also be performed by computer programs, which may exist in a variety of forms, both active and inactive. Such as, the computer programs may exist as software program(s) comprised of program instructions in source code, object code, executable code or other formats. Any of the above may be embodied on a computer readable medium, which includes storage devices and signals, in compressed or uncompressed form. Representative computer readable storage devices include conventional computer system RAM (random access memory), ROM (read only memory), EPROM (erasable, programmable ROM), EEPROM (electrically erasable, programmable ROM), and magnetic or optical disks or tapes. Representative computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general.

It will be understood that the features and examples above are not meant to limit the scope of the present disclosure to a single implementation, as other implementations are possible by way of interchange of some or all of the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an implementation showing a singular component should not necessarily be limited to other implementations including a plurality of the same component, and vice-versa, unless explicitly stated otherwise herein. Moreover, applicants do not intend for any term in the specification or claims to be ascribed to an uncommon or special meaning unless explicitly set forth as such. Further, the present disclosure encompasses present and future known equivalents to the known components referred to herein by way of illustration.

The present description of the specific implementations so fully reveals the general nature of the disclosure that others can, by applying knowledge within the skill of the relevant art(s) (including the contents of any documents cited and incorporated by reference herein), readily modify and/or adapt for various applications such specific implementations, without undue experimentation and without departing from the general concept of the present disclosure. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various implementations of the present disclosure have been described above, it should be understood that they have been presented by way of example, and not limitation. It would be apparent to one skilled in the relevant art(s) that various changes in form and detail could be made therein without departing from the spirit and scope of the disclosure. Thus, the present disclosure should not be limited by any of the above-described implementations but should be defined only in accordance with the following claims and their equivalents.

1. A computer-implemented method for determining a characteristic distance of an object-of-interest, the method comprising:
accessing a two-dimensional (2D) image of the object-of-interest, the 2D image comprising a plurality of pixels, each pixel being associated with a depth value indicative of a distance between an image sensing device that captured the 2D image and an entity present in the 2D image on the pixel;
determining a contour of the object-of-interest on the 2D image, the contour defining an outline of the object-of-interest on the 2D image;
determining an anchor pixel of the object-of-interest based on the contour thereof, the anchor pixel being selected among the plurality of pixels of the 2D image within the contour of the object-of-interest;
determining a target segment on the 2D image, the target segment containing the anchor pixel and crossing the contour in at least two pixels; and
determining a length of the target segment based on a pixel length thereof and the depth value of a given pixel of the 2D image, the length of the target segment being the characteristic distance of the object-of-interest.

2. The method of claim 1, wherein determining a contour of the object-of-interest comprises:
determining the contour of the object-of-interest by, for each pixel of the 2D image;
identifying the pixel as belonging to the object-of-interest in response to the corresponding depth value is below a distance threshold; and
discarding the pixel otherwise.

3. The method of claim 1, wherein determining an anchor pixel of the object-of-interest based on the contour thereof comprises employing a machine learning algorithm (MLA).

4. The method of claim 1, wherein determining an anchor pixel of the object-of-interest based on the contour thereof comprises:
determining a hull of the contour of the object-of-interest on the 2D image, thereby determining a plurality of hull feature points;
determining, based on relative distances between consecutive hull feature points, at least two points of interest along the contour; and
determining the anchor pixel based on the at least two points of interest.

5. The method of claim 4, wherein the hull is a convex hull, and determining at least two points of interest along the contour comprises:
determining relative distances between consecutive convex hull feature points along the convex hull;
identifying the two longest distances among the relative distances as two target hull segments;
determining, for each of the target hull segments, a corresponding point of interest, the point of interest being the point of contour between the convex hull feature points of the target hull segment where an orthogonal distance to the target hull segment is maximized.

6. The method of claim 5, wherein the anchor pixel is equidistant to the two points of interest.

7. The method of claim 6, further comprising adjusting a position of the anchor pixel by:
determining a digital framework of the object-of-interest, the digital framework being a ramified 2D tree structure, the digital framework being representative of a base structure of the object-of-interest; and
determining an adjusted anchor pixel based on the anchor pixel and the digital framework.

8. The method of claim 7, wherein determining the adjusted anchor pixel comprises:
determining an average line extending along the digital framework in a vicinity of the anchor pixel, the adjusted anchor pixel being a projection of the anchor pixel on the average line.

9. The method of claim 7, wherein determining a pixel length of the target segment comprises:
defining a base segment extending orthogonally to the average line at the adjusted anchor pixel;
defining a plurality of segments, each segment being angled at a pre-defined angle with respect to a consecutive segment of the plurality of segment.

10. The method of claim 7, wherein the given pixel is the adjusted anchor pixel.

11. The method of claim 1, wherein the given pixel is the anchor pixel.

12. The method of claim 1, wherein determining a target segment on the 2D image comprises:
determining a pixel length of a plurality of segments, each segment containing the anchor pixel and crossing the contour in at least two corresponding pixels; and
selecting one of the segments as the target segment based on a pre-determined pixel-distance criteria.

13. The method of claim 12, wherein the pre-determined pixel-distance criteria is fulfilled when the segment is a shortest segment of the plurality of segments.

14. The method of claim 1, wherein
determining a length of the target segment comprises:
defining a neighborhood of pixels around the given pixel;
determining pixel-scale value based on an average of ratios of a metric distance divided by a pixel distance between any two pixels of the neighborhood, the metric distance being determined based on the depth value associated with the corresponding pixels and intrinsic parameters of an imaging system that captured the 2D image;
determining a number of pixels of the target segment; and
determining a length of the target segment based on the pixel-scale value and the number of pixels of the target segment.

15. The method of claim 14, wherein the metric distance is an Euclidian distance.

16. The method of claim 1, further comprising executing a smoothing operation on the contour prior to determining the anchor pixel.

17. The method of claim 1, wherein:
accessing a 2D image of the object-of-interest comprises accessing a plurality of 2D images of the object-of-interest, the plurality of 2D images representing a same portion of the object-of-interest;
determining a contour of the object-of-interest on the 2D image comprises determining, for each 2D image of the plurality of 2D images, a contour defining an outline of the object-of-interest on the corresponding 2D image;
determining an anchor pixel of the object-of-interest based on the contour comprises determining, for each 2D image of the plurality of 2D images, a respective anchor pixel based on the corresponding contour associated with the 2D image;
determining a target segment on the 2D image comprises, determining, for each 2D image of the plurality of 2D images, a respective target segment containing the anchor pixel associated with the corresponding 2D image, the target segment crossing the contour associated with the corresponding 2D image in at least two pixels; and
determining a length of the second target segment comprises, determining, for each 2D image of the plurality of 2D images, a length of the corresponding target segment based on the pixel length thereof and the depth value of a given pixel of the corresponding 2D image, thereby providing a plurality of characteristic distance values for the object-of-interest.

18. The method of claim 17, further comprising:
determining a global characteristic distance of the object-of-interest by applying statistical operation to the plurality of characteristic distance values.

19. The method of claim 18, wherein the plurality of 2D images is a stream of ordered 2D images, the statistical operation being applied by:
ordering the plurality of characteristic distance values based on an order of their corresponding 2D image in the stream of images;
determining local minimums or local maximums in the plurality of ordered characteristic distance values; and
determining the global characteristic distance based on the average of the local minimums or local maximums.

20. (canceled)

21. (canceled)

22. (canceled)

23. (canceled)

24. (canceled)

25. (canceled)

26. (canceled)

27. (canceled)

28. A system for determining a characteristic distance of an object-of-interest, the system comprising a controller and a memory storing a plurality of executable instructions which, when executed by the controller, cause the system to perform the method of claim 1.

29. (canceled)
